(19) United States
(12) Patent Application Publication
(10) Pub. No.: US 2005/0099786 A1
(43) Pub. Date: May 12, 2005

(54) Yellow phosphor material and white light-emitting device using the same

(76) Inventors: Ru-Shi Liu, Hsinchu Hsien (TW); Yi-Shan Lin, Nan Tou Hsien (TW); Liang-Shen Chi, Yun-Lin Hsien (TW); Chien-Yuan Wang, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/702,593

(22) Filed: Nov. 7, 2003

(51) Int. Cl. F21V 19/04

(52) U.S. Cl. 362/20; 362/231

(57) ABSTRACT

A yellow phosphor material has a host with a formula (TbₓM_{y}Ce_{z})Al₅O₁₂, wherein x+y+z=3 , 3>x>0 and y≠0 and a Ce activator. M is selected from the group consisting of Sc, Y, Dy, Ho, Er, Tm, Yb, and Lu. By changing the diameter of metal ions, the crystal field thereof may be modulated to thereby alter the energy level of the excited state to which the activator is transferred upon irradiation by a specific wavelength of light. The phosphor can be used with a blue LED to form a white light source.

### FIELD OF THE INVENTION

The present invention relates to high-brightness white light-emitting device, especially to a high-brightness white light-emitting device with a purple-blue light or blue light emitting diodes in combination with suitable phosphor to provide white light.

### BACKGROUND OF THE INVENTION

It is known that the white light is mixed light of different colors. The white light, which is sensed by human eye as white color, at least includes two or more colors of light having different wavelengths. For example, when human eye is stimulated, at the same time, by the Red, Green, and Blue colors of light, or by blue light and yellowish light, a white color is sensed. Accordingly, there have been three major approaches to the formation of white light for now. The first is using R/G/B LEDs. By controlling the current passing the LED to generate white light. The second is using yellow/blue LEDs to generate white light. These two prior art methods has a common drawback in that when quality of one of the plural LEDs deteriorates, an accurate white light is no longer obtained. Furthermore, using plural LEDs is costly. Another known approach is using InGaN LED, which generates blue light that can be absorbed by phosphor dye or powders to emit yellowish light, that is mixed with blue light to produce white light. In 1996, a Japanese company, Nichia Kagaku Kogyo Kabushiki Kaisha (Tokushima), which is also known as “Nichia Chemical”, disclosed a method for generating white light by using a light-emitting diode (LED) that emits blue light absorbed by a phosphor material to emit yellowish light. This newly developed has no disadvantage of the former two prior art methods as described above. Besides, such LED has a simpler driving circuit and can be made by simple manufacturing process. Further, such InGaN LED has low power consumption and cost. As a result, the third approach (InGaN LED) is widely used for various white LED applications. However, so far, since most commercial InGaN type blue LED is made by using metal organic chemical vapor deposition (MOCVD), only blue LED with fixed wavelength can be obtained. There has been a strong need for providing a series of yellow light phosphor powders capable of modulating emitted blue light wavelengths in a range of from 430 nm to 490 nm.

The emitting wavelength of the conventional phosphor is adjusted by added with a hetero ion. For example, the phosphor with general formula Tb₃Al₅O₁₂:Ce can emit 556 nm yellow light. But, after adding Gd into this formula, the resulting Tb₃Al₅O₁₂:Ce formula can red shift the main wavelength to 556 nm.

However, in above-mentioned adjusting method, the hetero ion occupies only few ration of the overall phosphor. Serious deviation will occur if only slight error in the weight of the hetero ion.

### SUMMARY

It is an object of the present invention to provide a phosphor material used with a blue LED to manufacture a white light-emitting device, wherein the emitting color of the phosphor material is changed by changing the diameter of metal ions synthesizing the host matrix of the phosphor material.

It is another object of the present invention to provide a white light-emitting device with phosphor material which has changeable emitting color, thus rendering more flexibility to the blue LED candidate.

In the present invention, a yellow phosphor material has a host matrix with a formula (TbₓM_{y}Ce_{z})Al₅O₁₂, wherein x+y+z=3 , 3>x>0 and y≠0 and a Ce activator. M is selected from the group consisting of Sc, Y, Dy, Ho, Er, Tm, Yb, and Lu with radius smaller than and similar to that of Th. By changing the diameter of metal ions, the crystal field thereof may be modulated to thereby alter the energy level of the excited state to which the activator is transferred upon irradiation by a specific wavelength of light. The phosphor can be used with a blue LED to form a white light source.

The above mentioned wavelength-adjustable yellow phosphor material can be used with blue LED of different wavelength to form a white light source with optimal efficiency.

The white light-emitting device according to the present invention has following particular advantages:

1. The long-wavelength (470 nm) blue LED has more difficult manufacture than the short-wavelength (450 nm) blue LED. The wavelength-adjustable property of the phosphor according to the present invention can advantageously facilitate the use of blue LED in short-wavelength regime. Moreover, the short-wavelength (450 nm) blue LED has better color hue to enhance the color rendering property of white light-emitting device using the wavelength-adjustable phosphor.

2. In the present invention, the luminescent wavelength of phosphor is adjusted by modulating the crystal field of the host matrix of used phosphor instead of changing the amount of hetero ions. The process is simpler and more stable.

The various objects and advantages of the present invention will be more readily understood from the following detailed description when read in conjunction with the appended drawing, in which:

### BRIEF DESCRIPTION OF DRAWINGS

FIG. 1 shows the energy diagram of phosphor with Tb₃Al₅O₁₂ or (TbₓM_{y})Al₅O₁₂ as host matrix and with different Ce amount;

FIG. 2 shows an excitation spectrum (A) and emission spectrum (B1, B2) of the (Tb_{1.15}Y_{1.8}Ce_{0.05})Al₅O₁₂ phosphor.

FIG. 3 is the emission spectrum of the phosphor according to the present invention with different Tb and Y ratios; and

FIG. 4 shows the CIE coordinate of the phosphor according to the present invention with different Tb and Y ratios.

### DETAILED DESCRIPTION OF THE INVENTION

According to the present invention, a yellow phosphor material has a host matrix with a formula (TbₓM_{y}Ce_{z})Al₅O₁₂, wherein x+y+z=3 , 3>x>0 and y≠0 and a Ce activator. M is metal instead of Ce and preferably selected from the group consisting of Sc, Y, Dy, Ho, Er, Tm, Yb, and Lu with radius smaller than and similar to that of Tb. By changing the diameter of metal ions, the crystal field thereof may be modulated to thereby alter the energy level of the excited state to which the activator is transferred upon irradiation by a specific wavelength of light. Moreover, the energy split of 5d orbit of Ce ion is different due to diameter difference of metal (M) ion. The wavelength of emitted light from the phosphor is also different due to the energy gap variation between 5d excited state and 4f ground state. The variation of the diameter of metal ions will modulate the crystal field and blue shift the emission light of the phosphor.

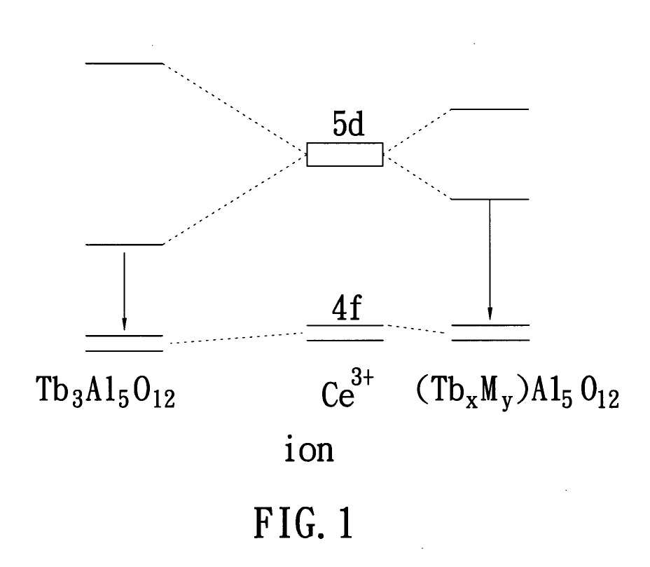

FIG. 1 explains the principle of modulation of the emitted wavelength in the phosphor according to the present invention. The electron configuration of three valance Ce is [Xe]4f¹, wherein the 4f orbital is split by spin-orbital coupling into ²F_{5/2} and ²F_{7/2}, and wherein the 5d orbital is split due to crystal field interactions. As shown in FIG. 1, the 5d orbit has larger split when the host matrix is Tb₃Al₅O₁₂, and the 5d orbit has smaller split when the host matrix is (TbₓM_{y})Al₅O₁₂. The crystal field is reduced and the 5d orbit has smaller split when metal M with smaller diameter is added to the host matrix. Therefore, the energy difference between the excited 5d orbit and the 4f ground state is increased to induce blue shift.

For substitutional solid solution, the doping concentration of hetero ions is influenced by the structural difference between the reactant and the product. For example, if three valance Y³⁺ is doped into the Tb₃Al₅O₁₂:Ce yellow phosphor and replaces Tb³⁺, three valance Y³⁺ will have good solubility in the Tb₃Al₅O₁₂:Ce yellow phosphor. This can be accounted by following reasons. The Tb₃Al₅O₁₂ and Y₃Al₅O₁₂ have the same space group Ia^{\overline{3}}d, and Y³⁺ ions and Tb³⁺ ions are both dodecahedron. Moreover, the difference between diameter of Y³⁺ ions (1.02 Å) and Tb³⁺ ions (1.04 Å) is only 2%, far less than the limit in substitutional solid solution. In comparison with the [Kr] electron configuration of Y³⁺, the electron configuration of Tb³⁺ ions is [Xe]4f⁸, and has less effective charge. Therefore, the doping of Y will reduce crystal field to change emitted wavelength.

A white light-emitting device can be implemented by using the yellow phosphor material according to the present invention and a blue LED with suitable wavelength. More particularly, the yellow phosphor has space group Ia^{\overline{3}}d and the blue LED has emitting wavelength of 430 nm to 500 nm (purple-blue light or blue light) such that the phosphor will emit light of 560 nm to 580 nm (yellow-green to orange-yellow) and mixed with the purple-blue light or blue light to provide white light.

The above-mentioned phosphor according to the present invention has adjustable emitting wavelength caused by variation in crystal field and can be used with blue LED of various wavelength to implement a white light-emitting device. Moreover, the phosphor according to the present invention can be prepared by simple solid-state reaction process.

According to the method disclosed in this application, the purple blue or blue light is generated by low power consumption light-emitting diodes in combination with a suitable phosphor material. After packaging, a high brightness white LED with good light properties operated at very low voltage is obtained.

The phosphor according to the present invention can be prepared by solid-state reaction process, Sol-Gel method and co-precipitation method and is exemplified by M=Y as following:

### A. EXAMPLE 1

### Solid-State Reaction Process

1. Preparing mixture for forming a composition having a stoichiometry of (TbₓY_{y}Ce_{0.05})Al₅O₁₂ (x=0.65 y=2.3 , x=1.15 y=1.8 , [symbol] x=2.95 y=0) by mixing and grinding Y(NO₃)₃.6H₂O, Al(NO₃)₃.9H₂O, Ce(NO₃)₃.6H₂O, and Tb₄O₇ matched the stoichiometry.

2. Placing thus-produced mixture in a crucible and heating the mixture for calcination in air at 1000° C. with a heating rate of 5° C./min for 24 hours and followed by cooling down at a cooling rate of 5° C./min to form intermediate powders.

3. Grinding the calcined powder and then placing the calcined powder again in the crucible for sintering in air for 24 hours with temperature ramp and drop of 5° C./min.

4. Placing the sintered powder in a H₂/N₂ (5%/95%) reductive ambient at 1500° C. for 12 hours for reduction. This reduces Ce⁴⁺ to Ce³⁺. It is noted that this step, which can improve light brightness, is optional.

### B. EXAMPLE 2

### Citrate Sol-Gel Process

1. Preparing a water solution of a composition having a stoichiometry of (TbₓY_{y}Ce_{0.05})Al₅O₁₂ (x=0.65 y=2.3, x=1.15 y=1.8, [symbol] x=2.95 y=0) by adding Y(NO₃)₃.6H₂O, Al(NO₃)₃.9H₂O, Ce(NO₃)₃.6H₂O, and Tb₄O₇ matched the stoichiometry to form a metallic salt and then placing the metallic salt to DI water.

2. Adding citrate of the same mole number as the metal ion as chelate agent to the water solution.

3. Adding alkali such as ammonia or ethylene diamine to the water solution in step 2 until the pH value thereof exceeding 10.

4. Heating the water solution in step 3 by 100˜120° C. until a sticky solution is formed.

5. Cooling the sticky solution and the thermal decomposing it in air with 300° C. to remove most organic material and nitride and oxide to obtain a bitumen ash.

6. Placing the ash in step 5 in a crucible and heating the mixture for calcination in air at 1000° C. with a heating rate of 5° C./min for 24 hours and followed by cooling down at a cooling rate of 5° C./min to form intermediate powders.

7. Grinding the calcined powder and then placing the calcined powder again in the crucible for sintering in air for 24 hours with temperature ramp and drop of 5° C./min.

8. Placing the sintered powder in a H₂/N₂ (5%/95%) reductive ambient at 1500° C. for 12 hours for reduction. This reduces Ce⁴⁺ to Ce³⁺. It is noted that this step, which can improve light brightness, is optional.

In this example, the chelate agent can use any organic or inorganic compound which can form chelate with metal ion in step 2. The alkali in step 3 can use any alkali organic compound which form colloid material with metal ion in step 2.

### C. EXAMPLE 3

### Co-Precipitation Process

1. Preparing a water solution of a composition having a stoichiometry of (TbₓY_{y}Ce_{0.05})Al₅O₁₂ (x=0.65 y=2.3, x=1.15 y=1.8, [symbol] x=2.95 y=0) by adding Y(NO₃)₃.6H₂O, Al(NO₃)₃.9H₂O, Ce(NO₃)₃.6H₂O, and Tb₄O₇ matched the stoichiometry to form a metallic salt and then placing the metallic salt to DI water.

2. Adding alkali such as ammonia or ethylene diamine to the water solution in step 1 until the pH value thereof exceeding 10.

3. Stirring the solution in step 2 and obtaining a white sticky solution by pumping and filtering process.

4. Thermal decomposing the white sticky solution in step 3 in air with 300° C. to remove most organic material and nitride and oxide to obtain a bitumen ash.

5. Placing the ash in step 5 in a crucible and heating the mixture for calcination in air at 1000° C. with a heating rate of 5° C./min for 24 hours and followed by cooling down at a cooling rate of 5° C./min to form intermediate powders.

6. Grinding the calcined powder and then placing the calcined powder again in the crucible for sintering in air for 24 hours with temperature ramp and drop of 5° C./min.

7. Placing the sintered powder in a H₂/N₂ (5%/95%) reductive ambient at 1500° C. for 12 hours for reduction. This reduces Ce⁴⁺ to Ce³⁺. It is noted that this step, which can improve light brightness, is optional.

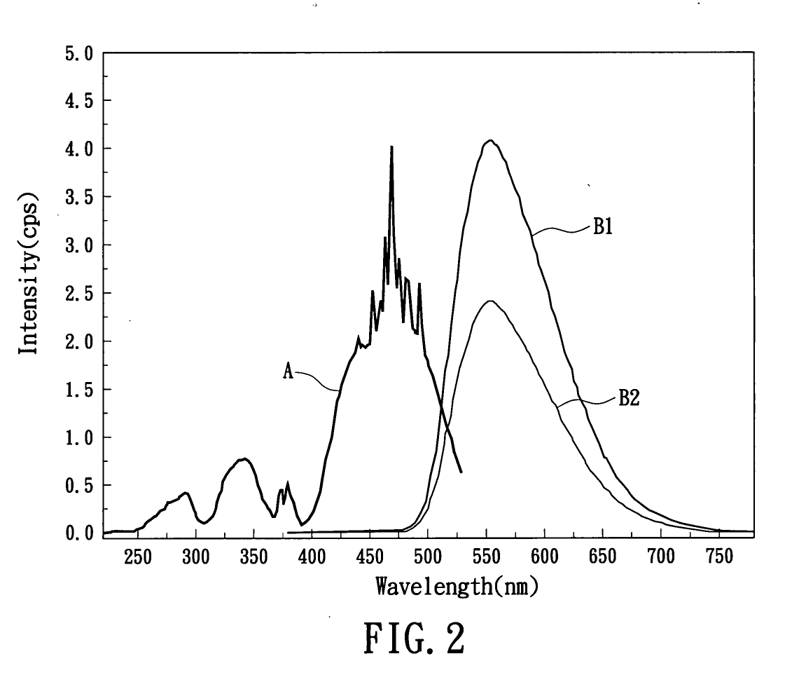

The phosphors prepared in above three exampled are then cooled and ground to powder. The spectral properties are then measured with excitation spectrum shown in FIGS. 2 to 4.

FIG. 2 shows the excitation spectrum A and emission spectrums B1, B2 for the (Tb_{1.15}Y_{1.8}Ce_{0.05})Al₅O₁₂ phosphor material according to the present invention, wherein the spectrum B1 is excited by 450 nm blue light and the spectrum B2 is excited by 457 nm blue light.

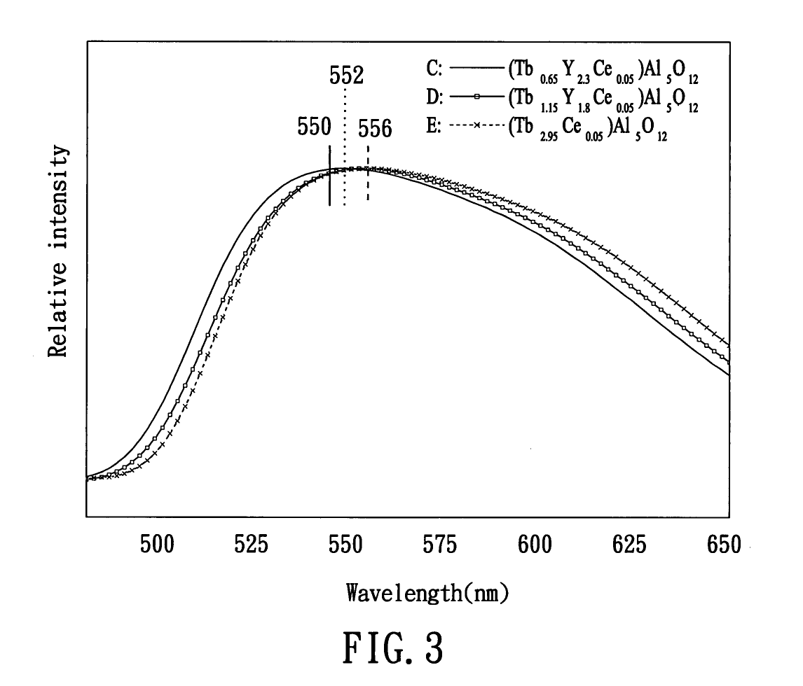

FIG. 3 shows the emission spectrum of phosphor according to the present invention with different Tb and Y ratios, wherein curve C is the emission spectrum corresponding to the phosphor with formula (Tb_{0.65}Y_{2.3}Ce_{0.05})Al₅O₁₂, curve D is the emission spectrum corresponding to the phosphor with formula (Tb_{1.15}Y_{1.8}Ce_{0.05})Al₅O₁₂, and curve E is the emission spectrum corresponding to the phosphor with formula (Tb_{2.95}Ce_{0.05})Al₅O₁₂. More particularly, the curve E is corresponding to the phosphor without adding Y, i.e., (Tb_{2.95}Ce_{0.05})Al₅O₁₂; and the emission spectrum thereof has a peak at 556 nm. The curve D is corresponding to the phosphor added Y, i.e., (Tb_{1.15}Y_{1.8}Ce_{0.05})Al₅O₁₂; and the emission spectrum thereof has a peak at 552 nm. The curve C is corresponding to the phosphor added more Y, i.e., (Tb_{0.65}Y_{2.3}Ce_{0.05})Al₅O₁₂; and the emission spectrum thereof has a peak at 550 nm. That is, the addition of Y will blue-shift the emission spectrum, and the effect of the variation of metal ion diameter can be validated.

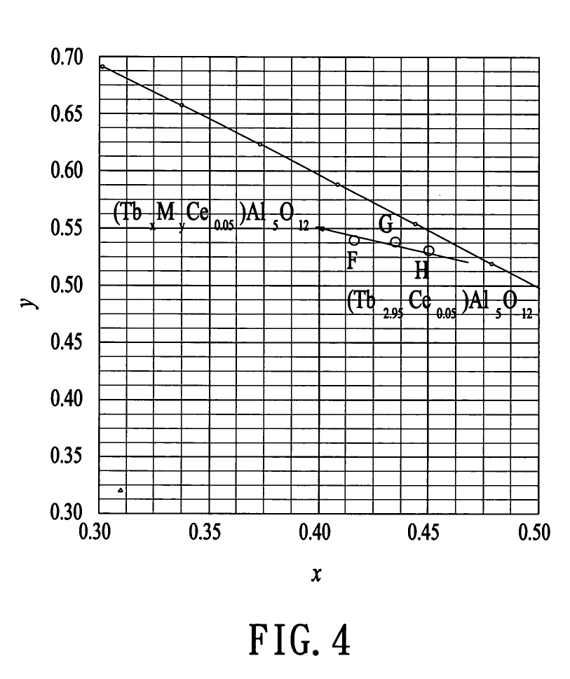

FIG. 4 shows the CIE coordinate of phosphor with different Y and Tb ratios, wherein point F is corresponding to the curve C, point G is corresponding to the curve D and point H is corresponding to the curve E. As can be seen in this chart, the CIE coordinate is moved toward shorter wavelength regime as the ratio of Y is increased.

Although the present invention has been described with reference to the preferred embodiment therefore, it will be understood that the invention is not limited to the details thereof. Various substitutions and modification s have suggested in the foregoing description, and other will occur to those of ordinary skill in the art. Therefore, all such substitutions and modifications are intended to be embrace within the scope of the invention as defined in the appended claims.

1. A white light-emitting device, comprising
a light-emitting diode for emitting a first light with predetermined wavelength; and
a phosphor receiving the light of the light-emitting diode and emitting a second light of different wavelength for mixing with the first light and forming a white light;
wherein the phosphor has a host matrix of (TbₓM_{y})Al₅O₁₂ and using Ce as activator, the phosphor has a formula (TbₓM_{y}Ce_{z})Al₅O₁₂, wherein x+y+z=3, 3>x>0, and y≠0, M is a metal selected from a group with radius smaller than and similar to that of Tb and except Ce,
the ratio of M is adjusted to change a crystal field in the host matrix, thus changing the wavelength of the second light.

2. The white light-emitting device as in claim 1, wherein M is selected from the group consisting of Sc, Y, Dy, Ho, Er, Tm, Yb, and Lu.

3. The white light-emitting device as in claim 1, wherein the light-emitting diode has a domination wavelength between 430 nm and 500 nm.

4. The white light-emitting device as in claim 1, wherein the phosphor has a domination wavelength between 560 nm and 580 nm.

5. The white light-emitting device as in claim 1, wherein the phosphor is made from a group consisting of metal oxide, nitrate, metal organic compound and metal salt.

6. The white light-emitting device as in claim 1, wherein the phosphor is made by a solid-state reaction process.

7. The white light-emitting device as in claim 1, wherein the phosphor is made by a chemical process.

8. The white light-emitting device as in claim 7, wherein the chemical process is a citrate sol-gel process.

9. The white light-emitting device as in claim 7, wherein the chemical process uses an alkali organic compound formed a gel with a metal ion chelate.

10. The white light-emitting device as in claim 7, wherein the citrate sol-gel process uses an inorganic compound or an organic compound, which can form a chelate with metal ion.

11. The white light-emitting device as in claim 7, wherein the chemical process is a co-precipitation process.

12. A phosphor used for a white light-emitting device and receiving a light with a first wavelength of the light-emitting diode and emitting light with a second wavelength different to the first wavelength and mixed with the light of the light-emitting diode to form a white light, the phosphor having a host matrix of (TbₓM_{y})Al₅O₁₂ and using Ce as activator,
wherein the phosphor has a formula (TbₓM_{y}Ce_{z})Al₅O₁₂, wherein x+y+z=3, 3>x>0, and y≠0, M is a metal selected from a group with radius smaller than and similar to that of Th and except Ce,
the ratio of M is adjusted to change a crystal field in the host matrix, thus changing the wavelength of the second light.

13. The phosphor as in claim 12, wherein M is selected from the group consisting of Sc, Y, Dy, Ho, Er, Tm, Yb, and Lu.

14. The phosphor as in claim 12, wherein the light-emitting diode has a domination wavelength between 430 nm and 500 nm.

15. The phosphor as in claim 12, wherein the phosphor has a domination wavelength between 560 nm and 580 nm.

16. The phosphor as in claim 12, wherein the phosphor is made from a group consisting of metal oxide, nitrate, metal organic compound and metal salt.

17. The phosphor as in claim 12, wherein the phosphor is made by a solid-state reaction process.

18. The phosphor as in claim 12, wherein the phosphor is made by a chemical process.

19. The phosphor as in claim 18, wherein the chemical process is a citrate sol-gel process.

20. The phosphor as in claim 18, wherein the chemical process is a co-precipitation process.
